(19) United States
(12) Patent Application Publication
(10) Pub. No.: US 2015/0271414 A1
(43) Pub. Date: Sep. 24, 2015

(54) DISPLAY APPARATUS AND DISPLAY METHOD

(71) Applicants: Olympus Imaging Corp., Tokyo (JP); Olympus Corporation, Tokyo (JP)

(72) Inventors: Akinobu SATO, Hachioji-shi, Tokyo (JP); Yoshiyuki FUKUYA, Sagamihara-shi, Kanagawa (JP); Osamu NONAKA, Sagamihara-shi, Kanagawa (JP)

(21) Appl. No.: 14/658,984

(22) Filed: Mar. 16, 2015

(30) Foreign Application Priority Data
Mar. 24, 2014 (JP) 2014-060534

(51) Int. Cl. H04N 5/232; H04N 5/247

(52) U.S. Cl. CPC H04N 5/23293; H04N 5/247; H04N 5/23245

(57) ABSTRACT

A display apparatus includes: a communication section performing signal transmission with each of a first image pickup section obtaining a first picked-up image and a second image pickup section performing image pickup from an angle different from an angle of an optical axis of the first image pickup section to obtain a second picked-up image of a same object; an instruction inputting section inputting an instruction to select an image to be a display target between the first picked-up image obtained by the first image pickup section and the second picked-up image obtained by the second image pickup section; and a display control section switching display of the first picked-up image and display of the second picked-up image, causing the display of the first picked-up image and the display of the second picked-up image to cooperate with each other, based on the instruction of the instruction inputting section.

### CROSS REFERENCE TO RELATED APPLICATION

This application claim is benefit of Japanese Application No. 2014-60534 in Japan on Mar. 24, 2014, the contents of which are incorporated by this reference.

### BACKGROUND OF THE INVENTION

1. Field of the Invention

The present invention relates to a display apparatus and a display method of displaying images from a plurality of image pickup sections.

2. Description of the Related Art

Recently, portable apparatuses equipped with a photographing function (photographing apparatuses), such as a digital camera, have been widespread. Some of the photographing apparatuses of this kind are provided with a display section and equipped with a function of displaying a photographed image. Some display a menu screen on the display section to facilitate operation of the photographing apparatus. Such a display section is often provided on a back of a portable apparatus body, and a user can perform a photographing operation while checking a through image displayed on the display section on the back when photographing.

Such a display apparatus adopted in a photographing apparatus is capable of displaying another image in an image by image processing or displaying two images in different areas simultaneously. As such an apparatus that acquires two images, Japanese Patent Application Laid-Open Publication No. 2009-147824 proposes an apparatus which, while acquiring video of a target object to be aimed, acquires a state around the target object simultaneously and records image pickup data in which the predetermined target object is aimed and image pickup data showing the state around the target object simultaneously.

### SUMMARY OF THE INVENTION

A display apparatus according to the present invention is a display apparatus capable of switching and displaying, for a same object, a first picked-up image obtained by performing image pickup from a first point of view and a second picked-up image obtained by performing image pickup from a second point of view different from the first point of view, the display apparatus including: a communication section performing signal transmission with each of a first image pickup section obtaining the first picked-up image and a second image pickup section performing image pickup from an angle different from an angle of an optical axis of the first image pickup section to obtain the second picked-up image; an instruction inputting section inputting an instruction to select an image to be a display target between the first picked-up image obtained by the first image pickup section and the second picked-up image obtained by the second image pickup section; and a display control section switching display of the first picked-up image and display of the second picked-up image, causing the display of the first picked-up image and the display of the second picked-up image to cooperate with each other based on the instruction of the instruction inputting section.

A display method according to the present invention is a display method of switching and displaying, for a same object, a first picked-up image obtained by performing image pickup from a first point of view and a second picked-up image obtained by performing image pickup from a second point of view different from the first point of view, the method including: performing signal transmission with each of a first image pickup section obtaining the first picked-up image and a second image pickup section performing image pickup from an angle different from an angle of an optical axis of the first image pickup section to obtain the second picked-up image; in accordance with an instruction to select one image of the first and second picked-up images as an image to be a display target, receiving the first picked-up image from the first image pickup section and displaying the one image; and in accordance with an instruction to select another image of the first and second picked-up images as an image to be a display target during the one image being displayed, receiving the second picked-up image from the second image pickup section and displaying the one image and the other image simultaneously, and, after that, displaying only the other image.

The above and other objects, features and advantages of the invention will become more clearly understood from the following description referring to the accompanying drawings.

### BRIEF DESCRIPTION OF THE DRAWINGS

FIG. 1 is a block diagram showing a photographing apparatus which includes a display apparatus according to a first embodiment of the present invention;

FIG. 2 is a circuit diagram showing an example of realizing the present embodiment by a tablet PC (personal computer) equipped with two lens style cameras;

FIG. 3 is an explanatory diagram showing an external appearance of the tablet PC in FIG. 2;

FIGS. 4A to 4C are explanatory diagrams for illustrating methods of arranging the cameras assumed in the present embodiment;

FIG. 5 is an explanatory diagram for illustrating setting for appropriately controlling a photographing angle of view;

FIG. 6 is a flowchart for illustrating camera control in lens style cameras 11 and control of a tablet PC 21;

FIGS. 7A to 7D are explanatory diagrams showing a switching operation and examples of display on a display screen 28a;

FIG. 8 is an explanatory diagram for illustrating angle-of-view adjustment;

FIG. 9 is a flowchart showing an operation flow adopted in a second embodiment of the present invention;

FIGS. 10A to 10D are timing charts for illustrating image communication at a time of transition;

FIGS. 11A to 11H are timing charts for illustrating communication at a time of transition of step S45;

FIGS. 12A to 12F are timing charts showing an operation at a time of immediate change;

FIG. 13 is a block diagram showing a third embodiment of the present invention;

FIG. 14 is an explanatory diagram for illustrating an external appearance of the third embodiment;

FIG. 15 is a flowchart showing an operation flow adopted in the third embodiment of the present invention; and

FIGS. 16A to 16C are timing charts for illustrating communication at a time of transition in the third embodiment.

### DETAILED DESCRIPTION OF THE PREFERRED EMBODIMENTS

Embodiments of the present invention will be described in detail below with reference to drawings.

### First Embodiment

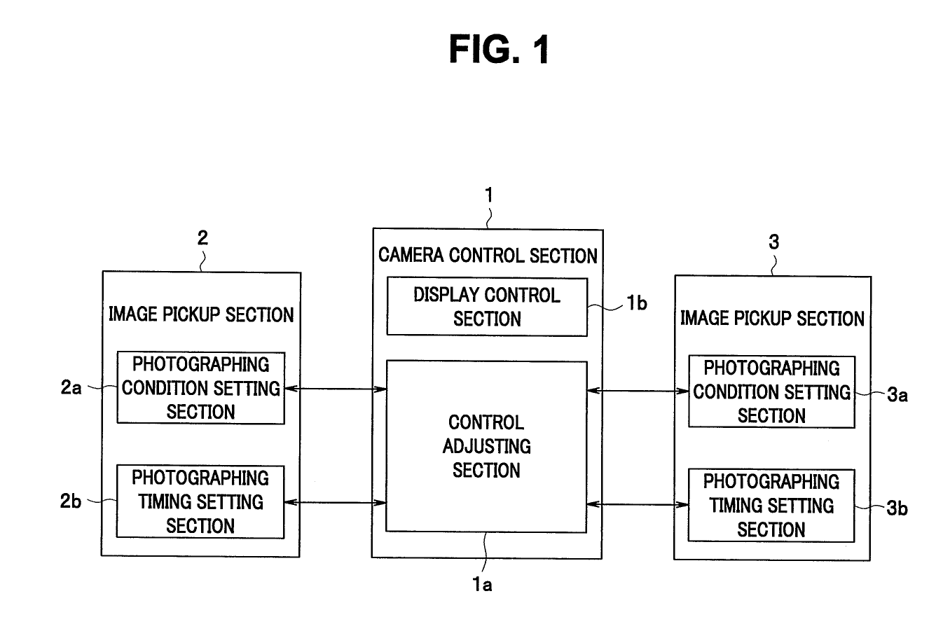

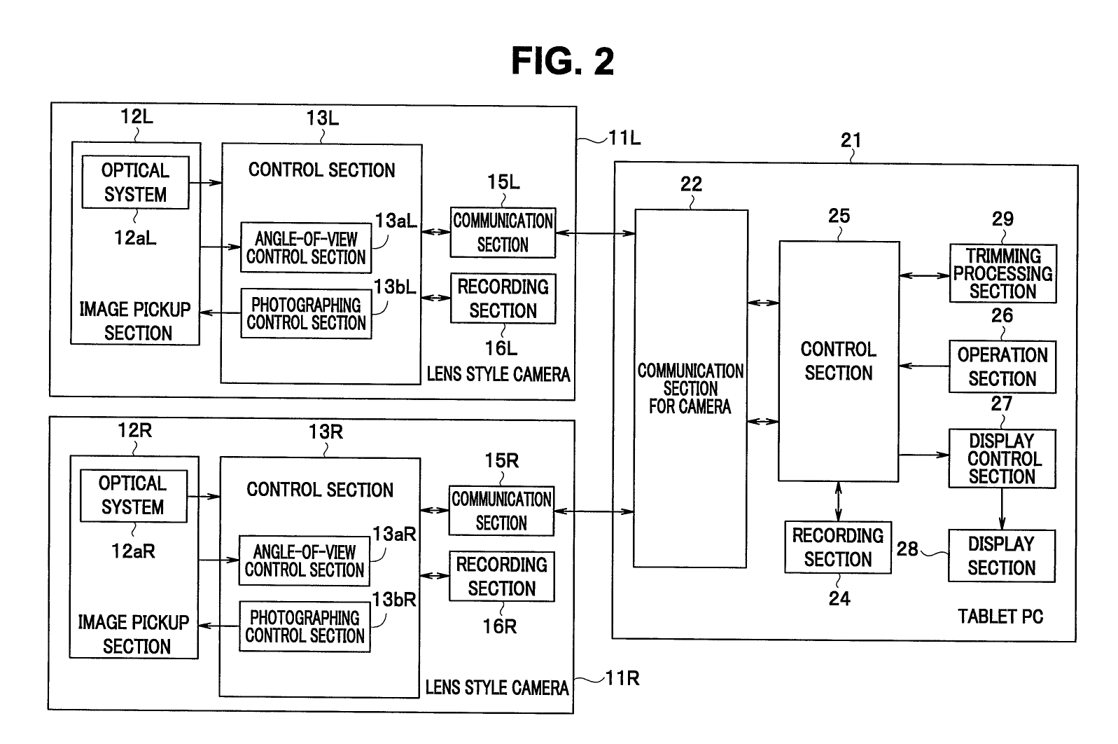

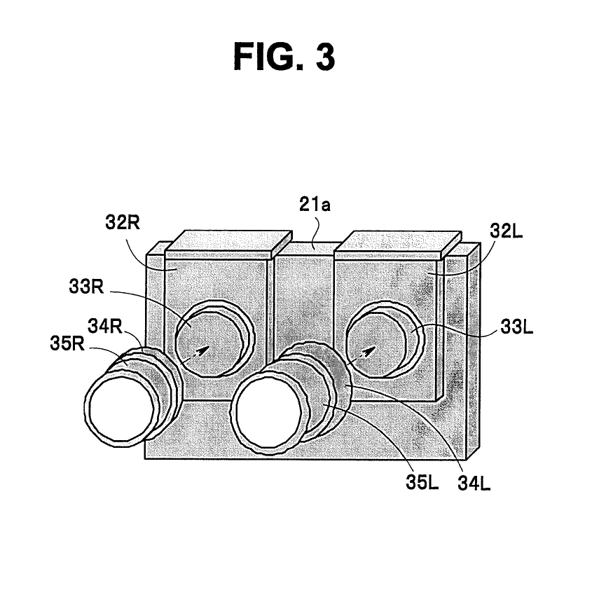

FIG. 1 is a block diagram showing a photographing apparatus which includes a display apparatus according to a first embodiment of the present invention, and FIG. 2 is a circuit diagram showing an example of realizing the present embodiment by a tablet PC (personal computer) equipped with two lens style cameras. FIG. 3 is an explanatory diagram showing an external appearance of the tablet PC in FIG. 2. Note that a smartphone or a mobile phone may be adopted instead of the tablet PC. FIG. 2 shows an example of adopting two lens style cameras externally attached to the tablet PC as two image pickup sections. However, for example, an internal camera built into the tablet PC and a lens style camera externally attached to the tablet PC may be adopted as the two image pickup sections.

In FIG. 1, image pickup sections 2 and 3 have image pickup devices not shown so that the image pickup sections 2 and 3 can perform image pickup of an object from mutually different points of view. A camera control section 1 has a control adjusting section 1a for controlling image pickup of the image pickup sections 2 and 3. The control adjusting section 1a is adapted to be able to control photographing condition setting sections 2a and 3a and photographing timing setting sections 2b and 3b of the image pickup sections 2 and 3 to control image pickup by the image pickup sections 2 and 3. The photographing condition setting sections 2a and 3a of the image pickup sections 2 and 3 perform setting of various photographing conditions. The photographing timing setting sections 2b and 3b of the image pickup sections 2 and 3 perform setting of photographing timings such as a timing of acquiring each frame.

The camera control section 1 can be configured with a processor such as a CPU not shown and may be operated in accordance with a program stored in a memory not shown. The camera control section 1 is provided with a display control section 1b. The display control section 1b can display picked-up images picked up by the image pickup sections 2 and 3 separately or simultaneously. In the present embodiment, since there is need for observing a same object from different angles, the control adjusting section 1a is adapted to be able to perform angle-of-view control for causing the image pickup sections 2 and 3 to pick up images of a same object, and information collection and instruction with regard to display and to display a warning display to a user and perform photographing control for photographing timings of the image pickup sections 2 and 3 and the like so that display switching between the images picked up by the image pickup sections 2 and 3 can be smoothly performed. Of course, objects of the image pickup sections 2 and 3 do not have to be a same object.

In FIG. 2, lens style cameras 11L and 11R correspond to the image pickup sections 2 and 3 in FIG. 1, respectively. The lens style cameras 11L and 11R have mutually a same configuration. When the lens style cameras 11L and 11 R are not distinguished from each other, they are referred to as lens style cameras 11. Same components in the lens style cameras 11L and 11R are given same reference numerals. When it is necessary to distinguish components in the lens style camera 11L and components in the lens style camera 11R from each other, L and R are attached to ends of reference numerals of the components in the lens style camera 11L and ends of reference numerals of the components in the lens style camera 11R, respectively. As described above, in order to cause separate cameras to cooperate with each other, it is necessary to figure out some way such as adjusting image pickup timings to be same by some control.

A tablet PC 21 corresponds to the camera control section 1 in FIG. 1. Note that, though FIG. 2 shows an example in which the camera control section 1 in FIG. 1 is configured with the tablet PC 21, the camera control section 1 may be provided in any one of the lens style cameras 11.

As shown in FIG. 3, attaching devices 32L and 32R can be removably attached to a case 21a of the tablet PC 21. The attaching devices 32L and 32R are provided with attaching sections 33L and 33R for attaching the lens style cameras 11L and 11R, respectively. The lens style cameras 11L and 11R are provided with attaching sections 34L and 34R, respectively, on proximal end sides thereof. The attaching sections 34L and 34R can be attached to the attaching sections 33L and 33R of the attaching devices 32L and 32R, respectively, by being fitted onto or screwed around the attaching sections 34L and 34R of the attaching sections 33L and 33R.

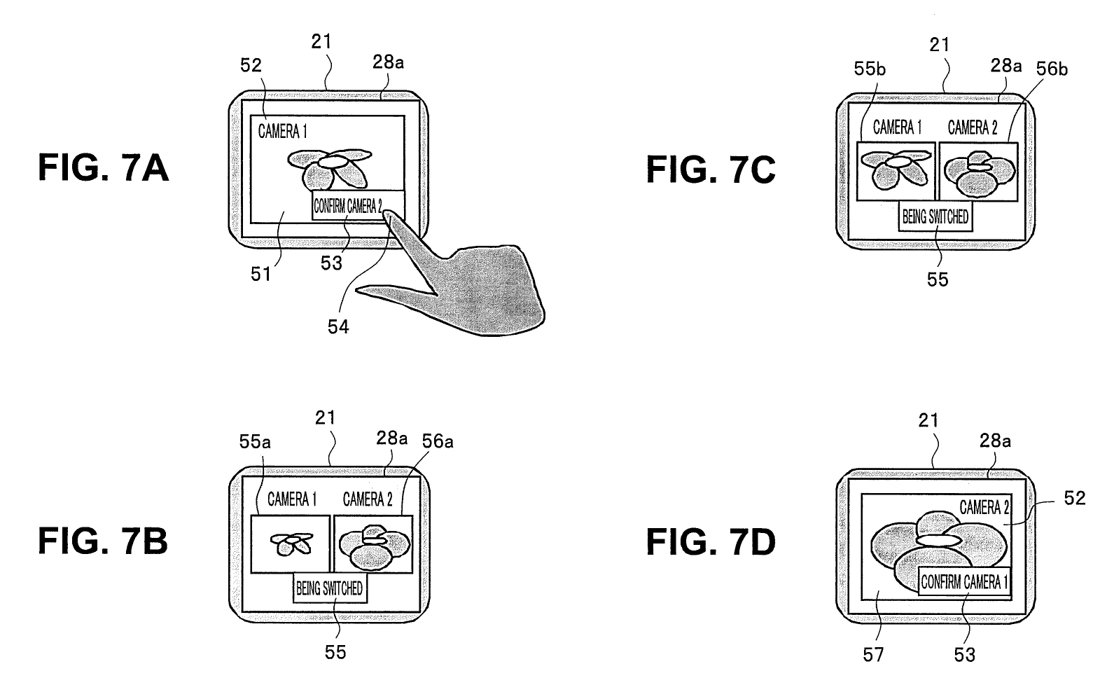

In FIG. 2, the tablet PC 21 is provided with a camera communication section 22. The lens style cameras 11 are provided with communication sections 15. The tablet PC 21 and the lens style cameras 11L and 11R are configured so as to mutually communicate via the communication sections 22 and 15. The tablet PC 21 is provided with a display section 28, and a display control section 27 corresponding to the display control section 1b in FIG. 1 is adapted to be able to cause picked-up images from the lens style cameras 11L and 11R to be displayed on a display screen 28a (see FIG. 7A) of the display section 28.

The lens style camera 11L is provided with an image pickup section 12L in which an optical system 12aL is housed in a barrel 35L, and the lens style camera 11R is provided with an image pickup section 12R in which an optical system 12aR is housed in a barrel 35R. The optical systems 12aL and 12aR have focus lenses movable to set a focused state by focusing, zoom lenses for changing magnification in the focused state, and the like in the barrels 35L and 35R, respectively. The optical systems 12a have mechanism sections not shown for driving the lenses and diaphragms.

The image pickup sections 12 are provided with image pickup devices not shown, which are configured with CCD or CMOS sensors, so that object images are led onto image pickup surfaces of the image pickup devices by the optical systems 12a. Control sections 13 corresponding to the photographing condition setting sections 2a and 3a and the photographing timing setting sections 2b and 3b in FIG. 1 are adapted to control the mechanism sections of the optical systems 12a to perform driving control of the focus lenses, the zoom lenses and the diaphragms.

The control sections 13 of the lens style cameras 11 are configured with CPUs or the like, and the control sections 13 control each section of the lens style cameras 11 based on signals from the tablet PC 21 to be described later. Photographing control sections 13b generate focus signals, zoom signals and diaphragm control signals to perform driving control of focusing, zooming and the diaphragms of the optical systems 12a. The photographing control sections 13b provide driving signals to the image pickup devices to control image pickup of an object at a predetermined photographing timing. Thereby, photographing timings of the control sections 13 at a time of photographing of a movie and at a time of photographing a still image are controlled. Angle-of-view control sections 13a are adapted to be able to control the image pickup sections 12 to adjust photographing angles of view by a photographing angle of view being specified from the tablet PC 21.

The control sections 13 are given picked-up images from the image pickup sections 12 and can give the picked-up images to recording sections 16 to record the picked-up images after performing predetermined image signal processing, for example, color adjustment processing, matrix conversion processing, noise removal processing and other various of signal processing. For example, IC memories can be adopted as the recording sections 16. The control sections 13 are adapted to be able to transfer the picked-up images to the tablet PC 21 via the communication sections 15.

The control sections 13 are also adapted to be able to transfer information about the lenses such as lens states of the zoom lens, the focus lens and the like and a diaphragm state to the tablet PC 21 via the communication sections 15. The information about the lenses includes information about distances in an optical axis direction, such as a point of focus and a range of a depth of field. The control sections 13 are adapted to transmit information about a photographing timing also to the tablet PC 21.

The communication sections 15 can communicate with the camera communication section 22 provided in the tablet PC 21 via a predetermined transmission line. As the transmission line, various wired and wireless transmission lines, for example, a USB (universal serial bus) cable or a wireless LAN transmission line such as WiFi (wireless fidelity) can be adopted. The control sections 13 are adapted so that, when communication with the tablet PC 21 is established, photographing is controlled by a control section 25 of the tablet PC 21, and the control section 13 can transfer various information about picked-up images and photographing to the tablet PC 21.

The tablet PC 21 has the control section 25 configured, for example, with a CPU, and the control section 25 controls each section of the tablet PC 21. The control section 25 outputs a driving signal for the image pickup devices to the control sections 13 of the lens style cameras 11L and 11R via the camera communication section 22 and receives picked-up images from the lens style cameras 11L and 11R. The control section 25 performs predetermined signal processing, for example, color adjustment processing, matrix conversion processing, noise removal processing, and other various kinds of signal processing for the picked-up images read out.

An operation section 26 is also arranged on the tablet PC 21. The operation section 26 is configured with various operation sections such as switches, keys and a software keyboard provided on the tablet PC 21, which are not shown, and is adapted to generate an operation signal based on a user operation and output the operation signal to the control section 25. The control section 25 controls each section based on the operation signal.

The control section 25 can perform processing related to recording and reproduction of a picked-up image. For example, the control section 25 can perform compression processing of a signal-processed photographed image and give the compressed image to a recording section 24 to cause the recording section 24 to record the compressed image. As the recording section 24, various recording media such as an IC memory can be adopted, for example, and the recording section 24 can record image information, voice information and the like to a recording medium.

The display control section 27 executes various kinds of processing related to display. The display control section 27 can be given a signal-processed photographed image from the control section 25 and give the photographed image to the display section 28. The display section 28 has the display screen 28a such as an LCD, and displays the image given from the display control section 27. The display control section 27 is also adapted to be able to cause various menu displays and the like to be displayed on the display screen 28a of the display section 28. The control section 25 can read out a picked-up image recorded in the recording section 24 and perform expansion processing thereof. The display control section 27 can reproduce the recorded image by giving the expansion-processed picked-up image to the display section 28.

A touch panel not shown is provided on the display screen 28a of the display section 28. The touch panel can generate an operation signal corresponding to a position on the display screen 28a which the user points at with a finger. The operation signal is provided to the control section 25. Thereby, the control section 25 is adapted to, when the user touches the display screen 28a or slides the finger on the display screen 28a, be able to detect various operations, such as a position the user touches, an operation of bringing fingers close to each other and then separating the fingers (a pinch operation), a slide operation and a position reached by the slide operation, a slide direction and a period of touching, and execute processing corresponding to a user operation. For example, switching between screens is performed by a touch operation.

Note that the display screen 28a is arranged, for example, such that it occupies substantially a whole area of a front of the case 21a of the tablet PC 21, and the user can check picked-up images displayed on the display screen 28a of the display section 28 at a time of photographing by the lens style cameras 11 and perform a photographing operation while checking the picked-up images.

The tablet PC 21 also has a trimming processing section 29. The trimming processing section 29 is adapted to, when a trimming range is specified by the control section 25, perform trimming of picked-up images from the lens style cameras 11L and 11R and output them.

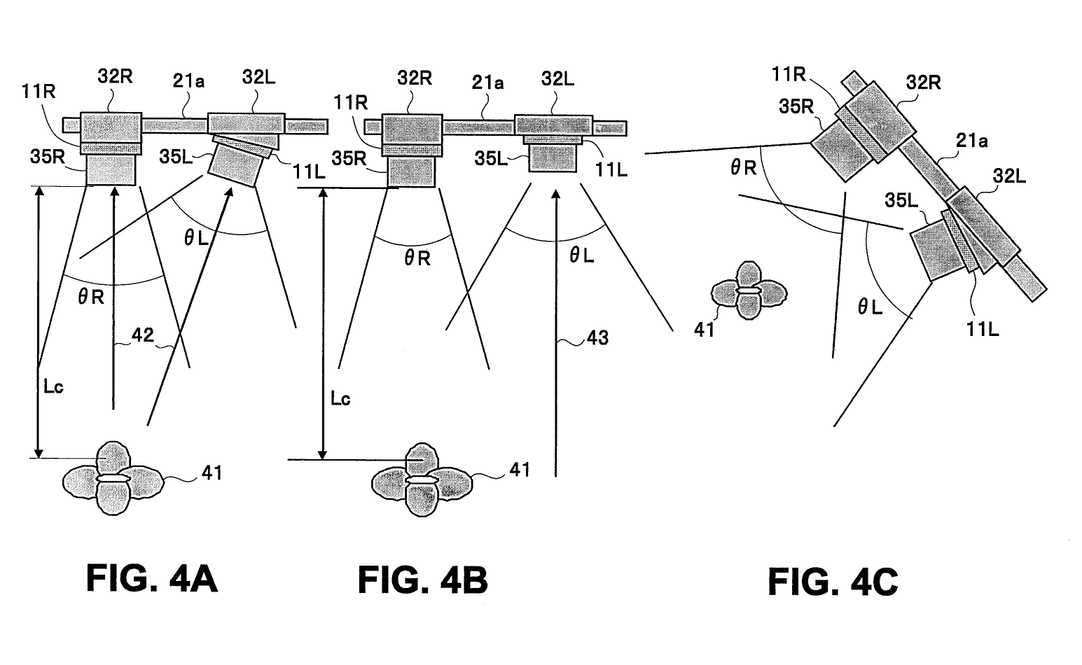

FIGS. 4A to 4C are explanatory diagrams for illustrating methods of arranging the cameras assumed in the present embodiment. FIGS. 4A and 4C show methods of arranging the cameras recommended in the present embodiment. The arrangements in FIGS. 4A to 4C can be realized by providing the attaching sections 33L and 33R in FIG. 3, causing the attaching sections 33L and 33R to be mutually inclined relative to a back of the case 21a of the tablet PC 21.

FIG. 4B shows an example of a case where both of optical axis directions of the lens style cameras 11L and 11R are orthogonal to the back of the case 21a of the tablet PC 21, and optical axes are parallel to each other. In the example of FIG. 4B, as for a flower 41 which is an object in the optical axis direction of the lens style camera 11R, the flower 41 is positioned within an angle of view θR of the lens style camera 11R. On the other hand, as for the lens style camera 11L, there may be a case where it is not possible to pick up an image of the flower 41 at a position at a distance Lc unless the angle of view θL is a wide angle, even though it is possible to pick up an image in a direction of a light beam 43, which is the optical axis direction.

In comparison, in an example of FIG. 4A, since the lens style cameras 11L and 11R are arranged being inclined in such a direction that the optical axes face with each other, the flower 41 which is an object is positioned in the optical axis directions of the lens style cameras 11L and 11R and can be certainly photographed by the lens style cameras 11L and 11R. Note that FIG. 4C shows an example in which the flower 41 which is an object is positioned near both of the optical axes of the lens style cameras 11L and 11R. In the example of FIG. 4C also, the flower 41 can be photographed by both of the lens style cameras 11L and 11R even when the angles of view θR and θL of the lens style cameras 11L and 11R are not wide angles. Thus, it is possible to express an object with a fuller atmosphere and looking more real by images photographed from a plurality of points of view.

In the present embodiment, it is enabled to photograph a same object with the two lens style cameras 11L and 11R and to perform photographing while smoothly switching picked-up images from the lens style cameras 11L and 11R with different points of view. In the present embodiment, in order to realize such smooth switching between picked-up images, photographing support is performed so that the user can certainly photograph a common object with each of the cameras 11. For example, the control section 25 is adapted to be able to control the display control section 27 to judge whether a photographing angle of view of each of the cameras 11 is appropriate or not, and cause a result of the judgment to be displayed as display for the photographing support.

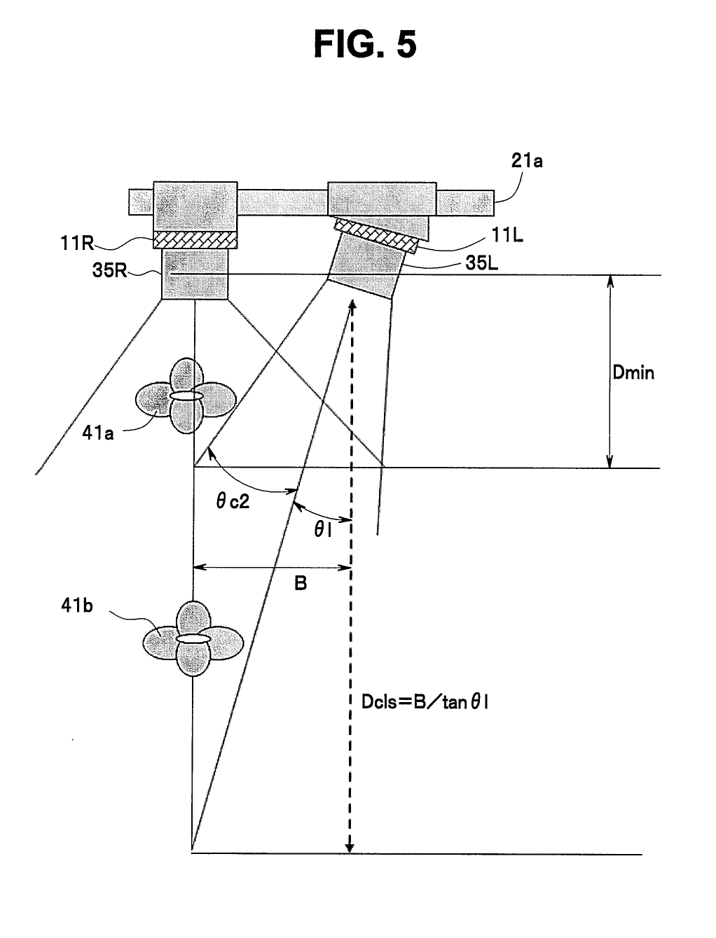

FIG. 5 is an explanatory diagram for illustrating setting for appropriately controlling the photographing angle of view.

It is assumed that flowers 41a and 41b, which are objects, are positioned on the optical axis of the lens style camera 11R. It is assumed that the lens style camera 11L is arranged with its optical axis inclined by an inclination θ1 relative to the optical axis of the lens style camera 11R. The flower 41b is positioned within photographing ranges of the lens style cameras 11L and 11R and can be photographed simultaneously by the lens style cameras 11L and 11R. On the other hand, the flower 41a is positioned outside the photographing range of the lens style camera 11L and cannot be photographed by the lens style camera 11L. A limit position of the photographing range of the lens style camera 11L is defined by a distance Dmin from the lens style camera, and the distance Dmin is determined.

A distance Dcls to a point of intersection between the optical axes of the lens style cameras 11L and 11R is given by:

Dcls=B/tan θ1

where a distance between the lens style cameras 11L and 11R is denoted by B.

If the angle of view of the lens style camera 11L is denoted by θc2, the following is obtained:

Dmin·tan(θ1+θc2)=B

Therefore, the limit distance Dmin can be shown by an equation (1) below:

Dmin=B/tan(θ1+θc2) (1)

The inclination θ1 and the distance B in the above equation (1) are fixed and known values which are determined by the attaching devices 32L and 32R attached to the lens style cameras 11L and 11R. The angle of view θc2 is a value which changes according to a zoom operation of the lens style camera 11L. However, it is a value according to control of an angle-of-view control section 13aL of the lens style camera 11L and is a value which the control section 25 can grasp.

The control section 25 can recognize a distance to an object based on information given from the lens style camera 11R. When the distance to the object is smaller than Dmin obtained by the above equation (1), the control section 25 can cause display indicating that it is not possible to photograph the object by one camera to be displayed. The control section 25 may be adapted to, when it is possible to make Dmin smaller than the distance to the object by a zoom operation, display a display to that effect. Further, the control section 25 may be adapted to, when the distance Dim smaller than the distance to the object is obtained by a zoom operation, compulsorily control the angle of view of the lens style camera 11L to enable the lens style camera 11L to photograph the object.

Note that distances from the lens style cameras 11L and 11R are determined based on lens principal points. However, even if distances from lens surfaces or lens attached surfaces are determined, errors are relatively small and can be ignored. As for the distance B also, it does not matter even if lengths of the lenses are ignored.

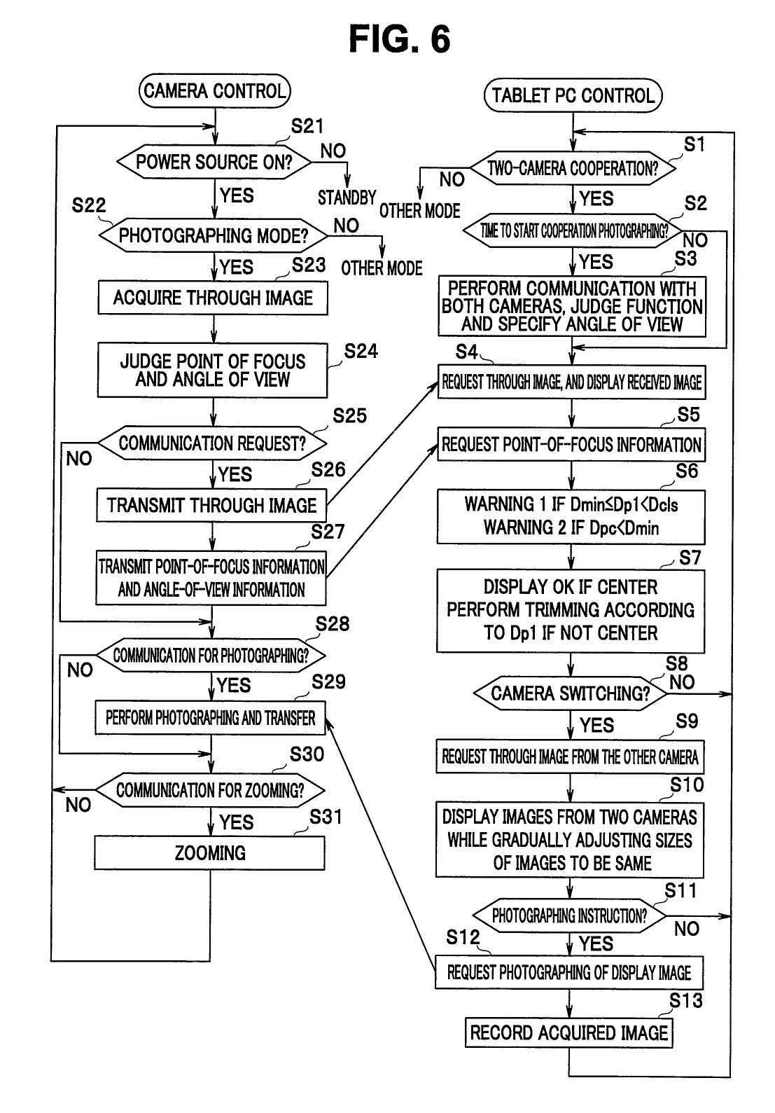

Next, an operation of the embodiment configured as described above will be described with reference to FIGS. 6 to 8. FIG. 6 is a flowchart for illustrating camera control in the lens style cameras 11 and control of the tablet PC 21. Note that, in FIG. 6, arrows connecting a camera control flow of the lens style cameras 11 and a control flow of the tablet PC 21 indicate that communication is performed by processing. The camera control in FIG. 6 indicates a flow common to the two cameras 11L and 11R.

Now, it is assumed that the user is going to photograph a common object by the two cameras 11L and 11R, as shown in FIG. 4A. In this case, the present embodiment makes it possible to smoothly switch from display and recording of a picked-up image from one camera to display and recording of a picked-up image from the other camera. FIGS. 7A to 7D are explanatory diagrams showing the switching operation and examples of display on the display screen 28a.

At step S21, the control sections 13 of the cameras 11L and 11R judge whether a power source has been turned on or not. When the power source is turned on, the control sections 13 judge whether a photographing mode has been specified or not (step S22). When the photographing mode has been specified, the control sections 13 control the image pickup sections 12 to pick up an image of the object. Picked-up images obtained by the image pickup sections 12 are taken in by the control sections 13 to obtain through images (step S23). At step S24, the control sections 13 acquire point-of-focus information Dp1 and angle-of-view information.

On the other hand, at step S1, the control section 25 of the tablet PC 21 judges whether a two-camera cooperation mode has been specified or not. When the two-camera cooperation mode is specified, the control section 25 judges whether it is a time to start cooperation photographing or not at step S2. If it is the time to start the cooperation photographing, the control section 25 performs camera communication with each of the cameras 11L and 11R to judge functions and performance of each of the cameras 11L and 11R and specify an angle of view of each of the cameras 11L and 11R at step S3. Note that the angle of view of each of the cameras 11L and 11R may be set to a maximum angle of view at initialization. At step S4, the control section 25 requests a through image from a camera determined in advance between the cameras 11L and 11R or a camera specified by the user and displays a received image. At this time, frame rates of the respective cameras and timings of respective frames are adjusted to be same so as to cause the cameras to operate as if they are a same camera. Of course, a photographing start timing and a frame rate may be specified by the tablet PC 21.

Now, it is assumed that, for example, the object is positioned on the optical axis of the camera 11R as shown in FIG. 4A, and the control section 25 requests a through image from the camera 11R.

At step S25, the control sections 13 of the cameras 11 judge whether there is a communication request or not. When the through image communication request occurs from the tablet PC 21, the camera 11R which receives the request transmits an acquired through image to the tablet PC 21 via the communication section 15R (step S26).

The control section 25 of the tablet PC 21 gives the through image received at step S4 to the display control section 27 to cause the display control section 27 to display the through image. FIG. 7A shows a display example in that case. A picked-up image 51 of the camera 11R is displayed on the display screen 28a of the display section 28. On the display screen 28a, a display 52 showing that the displayed picked-up image 51 is a picked-up image of a first camera (hereinafter referred to as Camera 1) corresponding to the camera 11R is also displayed. Note that, hereinafter, a second camera corresponding to the camera 11L will be referred to as Camera 2.

Next, the control section 25 requests transmission of the point-of-focus information Dp1, the angle-of-view information and the like. At step S27, each of the cameras 11L and 11R transmits the point-of-focus information Dp1 and the angle-of-view information. When receiving the point-of-focus information Dp1, the control section 25 judges whether it is possible to pick up images of a same object with the two cameras or not at step S6.

That is, by calculating the above equation (1) using the information acquired from each of the cameras 11L and 11R, the control section 25 judges whether or not the point-of-focus information Dp1 is smaller than Dcls and equal to or larger than Dmin and whether or not the point-of-focus information Dp1 is smaller than Dmin. The control section 25 also judges whether the point-of-focus information Dp1 corresponds to Dcls or not.

If the point-of-focus information Dp1 corresponds to Dcls, it means that the object is positioned on the optical axes of the cameras 11L and 11R. Therefore, at step S7, the control section 25 causes an OK display indicating that the picked-up images of both of the cameras 11L and 11R can be displayed at a center of the screen, to be displayed on the display screen 28a.

If the point-of-focus information Dp1 is smaller than Dcls and is equal to or larger than Dmin, the control section 25 causes a display (warning 1) indicating that, though images of the object have been picked up by both of the cameras 11L and 11R, the object of one camera 11L is not displayed at the center of the screen to be displayed on the display control section 27. If the point-of-focus information Dp1 is smaller than Dmin, the control section 25 causes the display control section 27 to display a display (warning 2) indicating that the object is not picked up by the camera 11L.

In a case of displaying the warning 1, the control section 25 may further perform trimming according to the point-of-focus information Dp1 at step S7 to perform control so that the object is displayed at the center of the screen.

Next, the control section 25 judges whether a camera switching operation has been mode or not at step S8. FIG. 7A shows a switching button display 53 for the camera switching operation. Note that, in this case, characters of “confirm Camera 2” for selecting the image of the camera 11L are displayed in the switching button display 53. By the user touching a display position of the switching button display 53 by a finger 54, the control section 25 can judge that a camera switching operation occurs.

When the camera switching operation is performed, a through image is requested from the other camera different from the camera which has outputted the through image displayed currently (step S9). That is, in this case, a through image is requested from the camera 11L.

In response to the through image request, the camera 11L transmits the image being picked up to the tablet PC 21 as a through image. When receiving the through image, the tablet PC 21 causes the through image to be displayed on the display screen 28a by the display control section 27.

FIGS. 7B and 7C show a state of change in a two-screen display in this case. On the display screen 28a, a picked-up image 55a by the camera 11R and a picked-up image 56a by the camera 11L are simultaneously displayed. Displays of “Camera 1” and “Camera 2” indicating that the picked-up images are those by the cameras 11R and 11L are also displayed near the images 55a and 56a. FIG. 7B shows a state immediately after switching from the camera 11R to the camera 11L. The size of the picked-up image 55a from the camera 11R is smaller in comparison with the picked-up image 56a from the camera 11L.

By controlling the angle of view of the camera 11L, the control section 25 can cause the sizes of picked-up images 55b and 56b from the cameras 11R and 11L to be almost same, as shown in FIG. 7C.

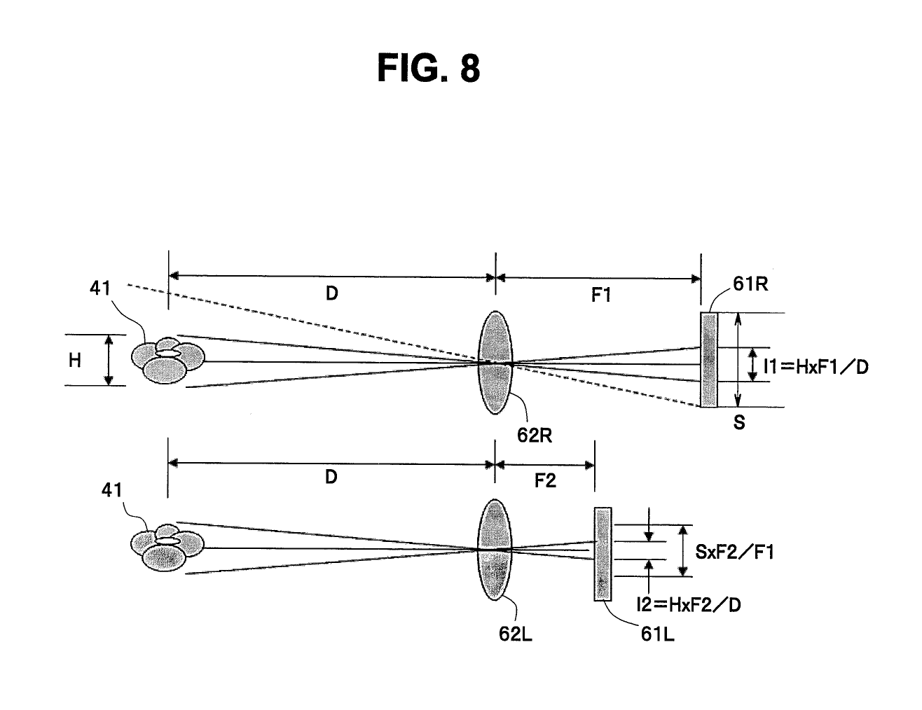

FIG. 8 is an explanatory diagram for illustrating angle-of-view adjustment in this case.

An upper side of FIG. 8 shows a state in which the camera 11R takes in an optical image from the flower 41, which is an object, onto an incidence plane of an image pickup device 61R via a lens 62R. A lower side of FIG. 8 shows a state in which the camera 11L takes in an optical image from the flower 41 onto an incidence plane of an image pickup device 61L via a lens 62L. Description will be made on an assumption that a size of the flower 41, a distance to the object, a length of the image pickup devices 61R and 61L, a focal distance of the image pickup device 61R and a focal distance of the image pickup device 61L are denoted by H, D, S, F1 and F2, respectively.

It is assumed that, in the camera 11R, the optical image of the flower 41 is formed within a range of a length l1 on an image pickup surface of the image pickup device 61R. It is assumed that, in the camera 11L, the optical image of the flower 41 is formed within a range of a length l2 on an image pickup surface of the image pickup device 61L. The length l1 is given by l1=H×F1/D. The length l2 is given by l2=H×F2/D. Therefore, by adjusting the angle of view so that the optical image of the flower 41 is formed within a range of F2/F1 of the length S of the image pickup device 61L, sizes of the images obtained by the cameras 11R and 11L become same. By such a device, a feeling of discontinuity given at a time of photographing one object is eliminated, and the user can make a confirmation easily and effortlessly. In a case of performing photographing like a movie, a camera shake is prevented, and a smooth transition effect is obtained.

Next, the control section 25 displays a picked-up image 57 from the camera 11L on a whole area of the display screen 28a as shown in FIG. 7D. On the display screen 28a, a display 52 showing that the displayed picked-up image 57 is a picked-up image of Camera 2 corresponding to the camera 11L is also displayed. The switching button display 53 for a camera switching operation is also displayed. Note that, in this case, characters of “confirm Camera 1” for selecting the image of the camera 11R are displayed in the switching button display 53.

At next step S11, the control section 25 judges whether a photographing instruction has been issued or not. If a photographing instruction has been given, a photographing request is issued to the camera which has outputted the picked-up image displayed currently. In this case, the photographing request is issued to the camera 11L. When detecting that communication for photographing has been done, at step S28, a control section 13L of the camera 11L performs photographing and transfers a picked-up image to the tablet PC 21 at step S29. The control section 25 of the tablet PC 21 gives the picked-up image transferred from the camera 11L to the recording section 24 to cause the recording section 24 to record the picked-up image.

Note that, when receiving a control signal for angle-of-view adjustment from the control section 25 of the tablet PC 21, the cameras 11 cause the process to transition from step S30 to step S31 and performs zoom processing for adjustment to a specified angle of view.

As described above, in the present embodiment, it is possible to, in a case of photographing a same object by two image pickup sections with different points of view, perform photographing support, for example, presenting information for obtaining a suitable angle of view to a user or automatically adjusting an angle of view and trimming so that the user can certainly photograph the common object with each image pickup section. It is also possible to perform photographing while smoothly switching between picked-up images from the image pickup sections with different points of view.

### Second Embodiment

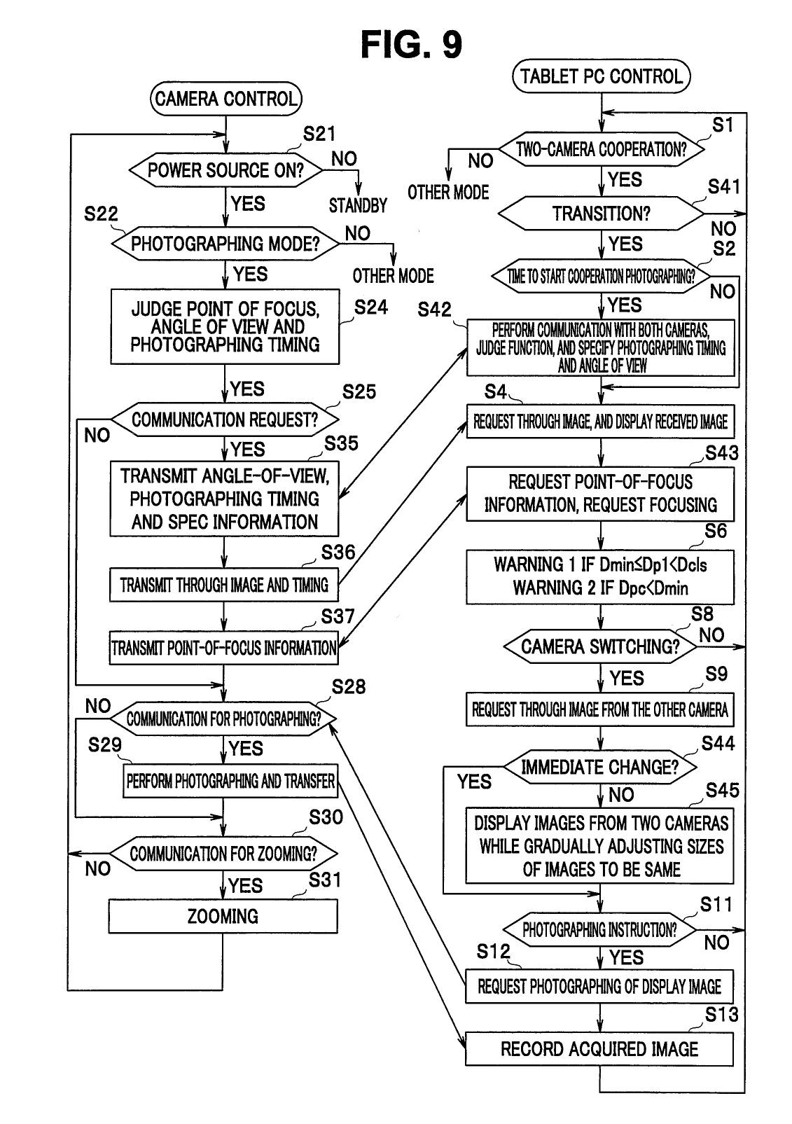

FIG. 9 is a flowchart showing an operation flow adopted in a second embodiment of the present invention. A hardware configuration in the present embodiment is similar to FIG. 2. FIG. 9 is for illustrating camera control in the lens style cameras 11 and control of the tablet PC 21. In FIG. 9, same procedures as those in FIG. 6 are given same reference numerals, and description thereof will be omitted.

There may be a case where WiFi or the like is adopted for communication between the lens style cameras 11L and 11R and the tablet PC 21. When the communication section of the tablet PC 21 can secure only a communication line of one system, it is necessary for the tablet PC 21 to perform time-division communication with each of the lens style cameras 11L and 11R. In this case, it is conceivable that, at a time of switching from a picked-up image of one camera to a picked-up image of the other camera, a period during which an image is not displayed may occur or discontinuity may occur in an image, as shown in FIGS. 7A to 7D. Even in such a case, the present embodiment controls, for example, a photographing timing and the like so that the images can be smoothly switched.

At step S41 in FIG. 9, it is judged whether screen transition is being performed or not. For example, a state that both images are displayed while switching from one picked-up image to the other picked-up image is being performed, as in FIGS. 7B and 7C, is judged to be a state of transition being performed. In a case of displaying only a picked-up image from one camera, a problem does not especially occur, and, therefore, the process is returned to step S1. In a case where image transition occurs, it is necessary to consider how to perform communication at a time of switching images.

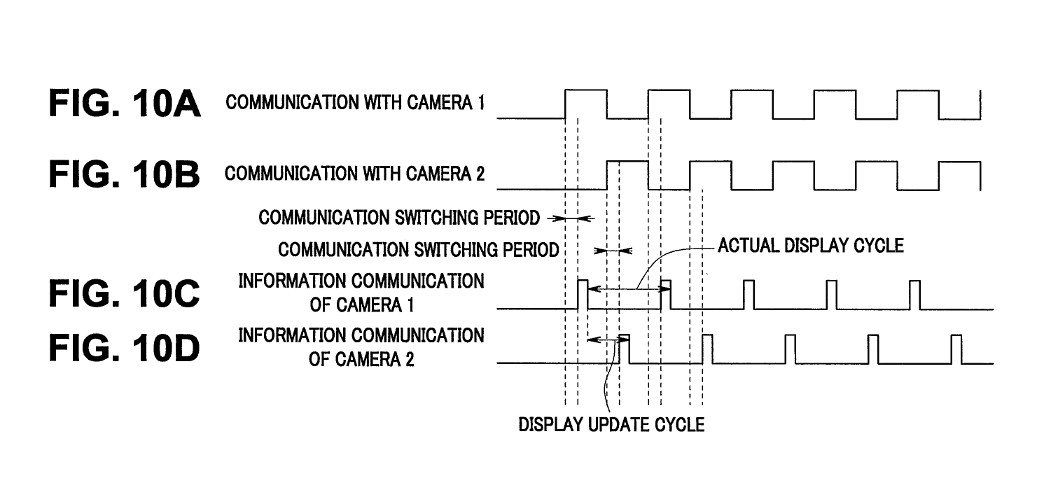

FIGS. 10A to 10D are timing charts for illustrating image communication at a time of transition between display images. In FIGS. 10A to 10D, it is shown that communication is performed during a high level (H) period, and communication is not performed during a low level (L) period. More particularly, FIG. 10A shows a period of communication with Camera 1, and FIG. 10B shows a period of communication with Camera 2. FIG. 10C shows a period of information communication from Camera 1, and FIG. 10D shows a period of information communication from Camera 2. As shown in FIGS. 10A and 10B, the tablet PC 21 has only a communication line of one system. Therefore, between the tablet PC 21 and Cameras 1 and 2, communication cannot be simultaneously performed, but time-division communication is performed.

In order to perform communication between the tablet PC 21 and Cameras 1 and 2, a communication establishment processing period is set at a beginning of a communication period in FIGS. 10A and 10B. Since communication of image data is performed after the communication establishment processing period as shown in FIGS. 10C and 10D, a cycle of an information communication period shown in FIG. 10C is a display cycle of Camera 1 on the display screen 28a of the tablet PC 21. Similarly, a cycle of an information communication period shown in FIG. 10D is a display cycle of Camera 2. During transition between displays, picked-up images of Cameras 1 and 2 are simultaneously displayed on the display screen 28a. At this time, control is performed so that an image acquired from communication with Camera 1 and an image acquired from communication with Camera 2 are simultaneously displayed. Therefore, as for a screen display, a cycle corresponding to ½ of the display cycle of each camera is a display update cycle on the display screen 28a.

At a time of the transition, the control section 25 of the tablet PC 21 causes the process to transition to step S2. In the present embodiment, at the time of starting the cooperation photographing, communications with both cameras are performed at next step S42 to perform judgment about functions and angle of views and acquire photographing timing information from one camera from which a picked-up image is currently being received.

Now, it is assumed that a state of displaying a picked-up image from Camera 1, between Cameras 1 and 2, transitions to a state of displaying picked-up images of both of Cameras 1 and 2 as shown in FIGS. 7A and 7B First, the tablet PC 21 receives and displays the picked-up image of Camera 1. In this case, the control section 25 acquires information about a photographing timing from Camera 1. The control section 25 requests a through image at step S4. Description will be made later on securing image smoothness by managing such timing information.

At step S5, the control section 13 of Camera 1 transmits the information about a photographing timing together with an angle of view and specification information. At step S36, the control section 13 transmits a through image and information for timing adjustment in response to the through image transmission request.

At step S43, the control section 25 of the tablet PC 21 requests Camera 1 to transmit point-of-focus information. Camera 1 transmits point-of-focus information Dp1. The control section 25 of the tablet PC 21 receives the point-of-focus information Dp1 and transmits information about a focusing position to Camera 2 using the point-of-focus information Dp1.

The control section 25 can control image pickup by Camera 2 based on the various pieces of information about image pickup by Camera 1 obtained through steps S42, S4 and S43, and smooth camera switching is enabled. When camera switching occurs at step S8, the control section 25 judges whether immediate change is performed or not at step S44. The immediate change means that, at a time of camera switching, the state in FIG. 7A is directly changed to the state in FIG. 7D without displaying picked-up images of both of Cameras 1 and 2. When the immediate change is not performed, the control section 25 displays the images from the two cameras while gradually adjusting sizes of the images to be same at step S45.

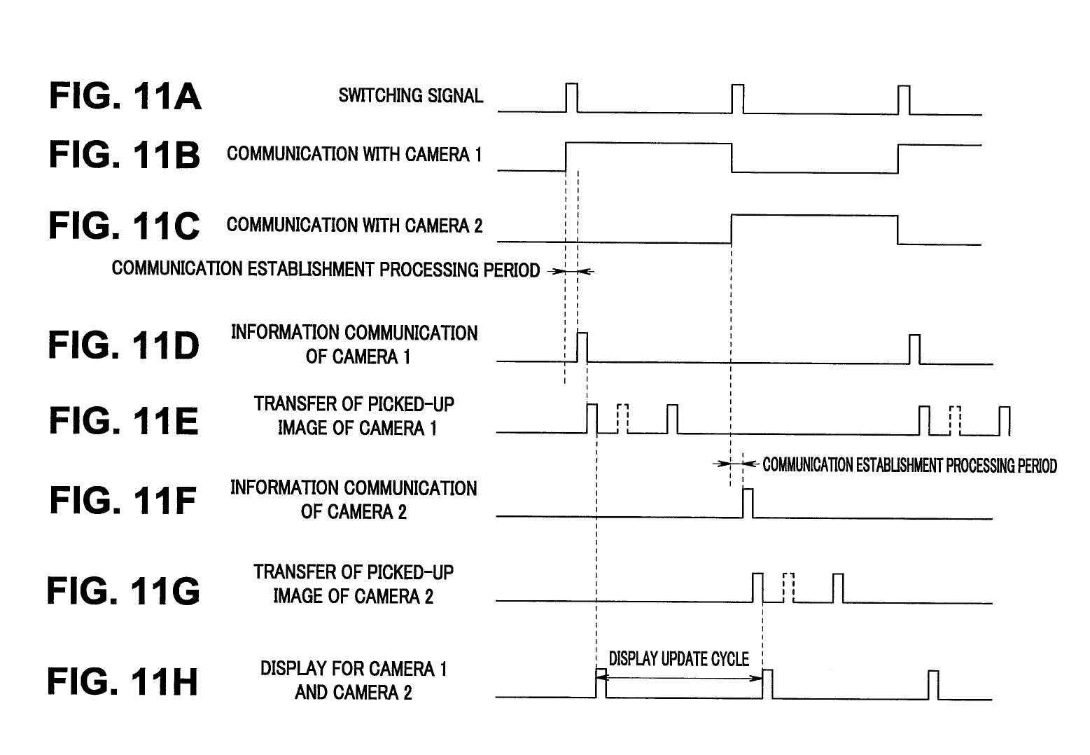

FIGS. 11A to 11H are timing charts for illustrating communication at a time of the transition of step S45. FIG. 11A shows a switching signal for controlling communication switching between Cameras 1 and 2 in time-division communication at the time of transition. FIGS. 11B and 11C show communication with Camera 1 and communication with Camera 2, respectively. FIGS. 11D and 11E show information communication and image pickup/transfer of Camera 1, respectively. FIGS. 11F and 11G show information communication and image pickup/transfer of Camera 2, respectively. FIG. 11H shows display update for Cameras 1 and 2. Note that a pulse-shaped part in FIGS. 11A to 11H indicates not an actual communication period but a communication timing.

The control section 25 gives a switching signal to the camera communication section 22 to switch between communication with Camera 1 and communication with Camera 2. As shown in FIGS. 11A, 11B and 11D, a predetermined period after start of a period of communication with Camera 1 is the communication establishment processing period, and, after elapse of the period, communication of the information about the specification and the angle of view is performed between Camera 1 and the tablet PC 21. Then, image pickup is performed by Camera 1, and a picked-up image is transferred to the tablet PC 21.

During transition, each camera holds a picked-up image and transmits the picked-up image in a time period shorter than a photographing time period. Thereby, even in a case of performing time-division transmission of image data of both of Cameras 1 and 2, all picked-up images of Cameras 1 and 2 can be transferred. Note that, though FIG. 11E shows a state of such high-speed transfer by a display in which transmission of a plurality of pieces of image pickup data is performed during one communication period, transmission of the respective pieces of image pickup data is continuously performed, and a transfer rate can be appropriately set. The transmission of the image picked-up data includes, for example, transmission of pixel data for auto focus by an image surface phase difference method (broken line parts).

As shown in FIGS. 11A, 11C, 11F and 11G, the communication with Camera 2 is similar to the communication with Camera 1, and transfer of information and an image is performed between Camera 2 and the tablet PC 21 during a period during which communication with Camera 1 is not performed.

FIG. 11H shows display update of a display screen, and picked-up images from Cameras 1 and 2 are displayed even when communication between Camera 1 and the tablet PC 21 is being performed. In this case, by the display control section 27 performing reduction processing of, for example, the picked-up image from Camera 1 to be a size shown in FIGS. 7B or 7C and temporarily stores the reduced picked-up image, then, by similarly performing reduction processing of the picked-up image from Camera 2 obtained later, and, after that, combining the picked-up image from Camera 2 with the reduced image of Camera 1 which has been temporarily stored to form a display image, the picked-up images are simultaneously displayed. Similarly, when communication between Camera 2 and the tablet PC 21 is being performed, picked-up images from Cameras 1 and 2 are displayed. The display control section 27 may perform trimming and angle-of-view adjustment in addition to the reduction processing.

In the information communication in FIGS. 11D and 11F, not only transmission of an angle of view, information about a focus and information about a photographing timing from a camera side to the tablet PC 21 is performed but also, with regard to the pieces of information, transmission of information from the tablet PC 21 to the camera side is performed. For example, when photographing timing information from Camera 1 which has displayed a picked-up image first is transmitted to the tablet PC 21, the tablet PC 21 transmits information for specifying a photographing timing of Camera 2 to Camera 2 based on the photographing timing information. Thereby, the photographing timing of Camera 2 from the photographing timing of Camera 1 is continuously controlled. Thus, it is possible to, at picked-up image transition from Camera 1 to Camera 2, prevent occurrence of frame dropping, frame repetition, display timing deviation and the like. That is, image frame acquisition timings of the respective cameras are adjusted to be same, and the respective cameras become as if they were one camera having two points of view.

Similarly to the first embodiment, it is possible to display a picked-up image from Camera 1 and a picked-up image from Camera 2 with similar sizes by controlling angles of view and trimming, and smooth transition is possible.

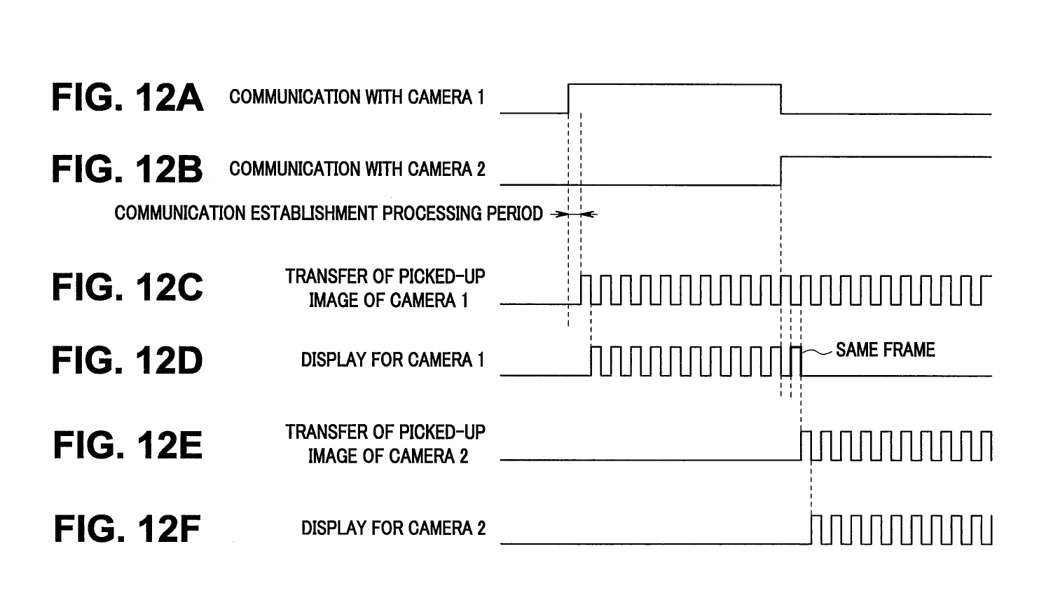

FIGS. 12A to 12F are timing charts showing an operation at a time of immediate change. FIGS. 12A and 12B show communication with Camera 1 and communication with Camera 2 at the time of immediate change, respectively. FIGS. 12C and 12D show image pickup/transfer and a display timing of Camera 1, respectively. FIGS. 12E and 12F show image pickup/transfer and a display timing of Camera 2, respectively.

As shown in FIGS. 12A and 12C, after the control section 25 instructs the communication section 22 to start communication with Camera 1, communication with Camera 1 is started after a predetermined communication establishment processing period, and a picked-up image of Camera 1 is transferred. As shown in FIG. 12D, the image is displayed on the display screen 28a after being transferred.

In a case where immediate switching from display of the picked-up image of Camera 1 to display of a picked-up image of Camera 2, the control section 25 instructs the communication section 22 to start communication with Camera 2. After the predetermined communication establishment processing period after the start, communication with Camera 2 is started, and a picked-up image of Camera 2 is transferred. In this case, a period occurs during which a picked-up image is transferred neither from Camera 1 nor from Camera 2 as shown in FIGS. 12D to 12E. Therefore, the control section 25 keeps the picked-up image of Camera 1 during the period and causes the picked-up image to be repeatedly displayed on the display screen 28a until it becomes possible to display the picked-up image from Camera 2. Thereby, it is possible to cause an object to be continuously displayed on the display screen 28a. That is, handoff of image pickup as well as handoff of display can be smoothly performed without delay.

As described above, in the present embodiment, effects similar to those of the first embodiment can be obtained. In addition, when a tablet PC and a camera can perform only one-to-one communication, the tablet PC performs time-division communication with two cameras, and controls image pickup by transferring information about photographing of one camera to the other camera, and, thereby, it is possible to continuously display picked-up images from the respective cameras, and it is possible to smoothly switch the images. Though an image pickup timing of one camera is adjusted to that of the other camera here, the tablet PC may specify a timing to both cameras to control and synchronize timings of both cameras. In the case of repeatedly display a picked-up image until display of a picked-up image from Camera 2 becomes possible, switching between displays may be performed by fading in/fading out the displays. Without such detailed control, a feeling of discontinuous is given during slow-motion or fast-forward display.

### Third Embodiment

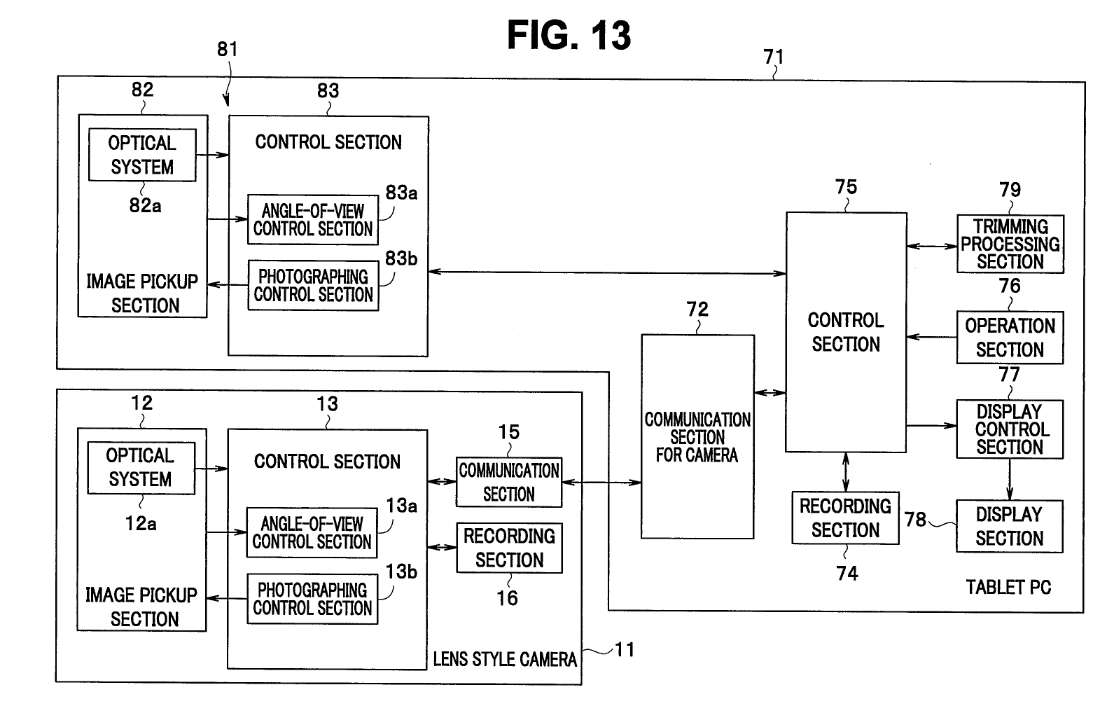

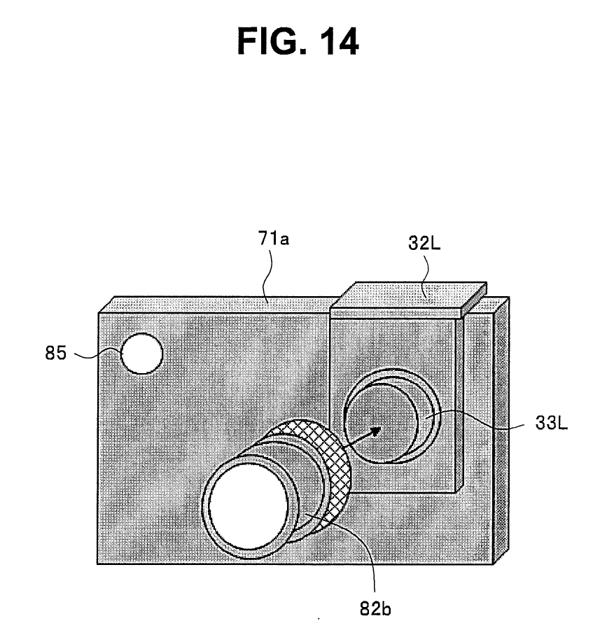

FIG. 13 is a block diagram showing a third embodiment of the present invention. FIG. 14 is an explanatory diagram for illustrating an external appearance of the third embodiment. In FIG. 13, same components as those in FIG. 2 are given same reference numerals, and description thereof will be omitted.

The present embodiment is an example in which a smartphone having an internal camera and a lens style camera attached to a case of the smartphone are adopted as two image pickup sections. Similarly to the first embodiment, the present embodiment makes it possible to perform cooperated display, for example, shown FIGS. 7A to 7D, and, for example, causes images similar to those in FIGS. 7A to 7D to be displayed on a display screen of the smart phone.

In FIG. 13, a lens style camera 11 has a configuration similar to that in FIG. 2. Configurations of a camera communication section 72, a recording section 74, a control section 75, an operation section 76, a display control section 77, a display section 78 and a trimming processing section 79 constituting a smartphone 71 are similar to those of the camera communication section 22, the recording section 24, the control section 25, the operation section 26, the display control section 27, the display section 28 and the trimming processing section 29 constituting the tablet PC 21 in FIG. 2, respectively. An internal camera 81 in the smartphone 71 is constituted by an image pickup section 82 and a control section 83 having configurations similar to those of image pickup sections 12 and a control section 13 of the lens style camera 11, respectively.

In FIG. 14, an attaching device 32L is attached to a case 71a of the smartphone 71, and the lens style camera 11 is attached to an attaching section 33L of the attaching device 32L. In the internal camera 81 of the smartphone 71, the image pickup section 82 picks up an optical image of an object which has entered via a lens 85 provided on a back of the case 71a and outputs an image pickup output to the control section 75.

In the present embodiment, the control section 83 of the internal camera 81 is adapted to give and receive information about image pickup to and from the control section 75. That is, the control section 75 can acquire the information about image pickup of the internal camera 81 without performing communication by the camera communication section 72, and, therefore, the camera communication section 72 has to perform communication only with the lens style camera 11.

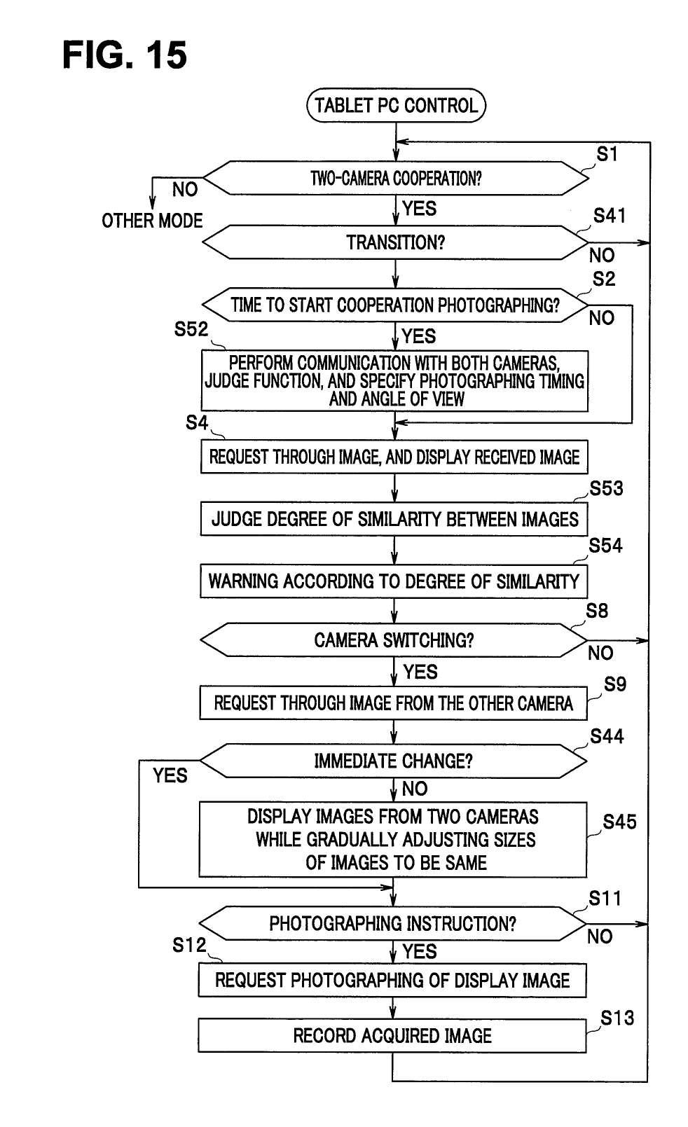

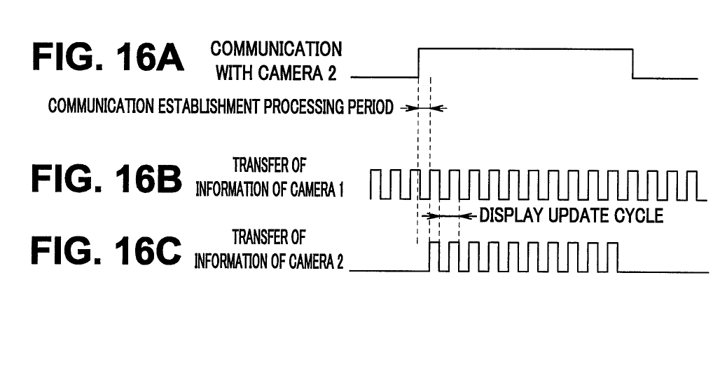

Next, an operation of the embodiment configured as described above will be described with reference to FIG. 15 and FIGS. 16A to 16C. FIG. 15 is a flowchart showing an operation flow adopted in the third embodiment of the present invention. FIG. 15 is for illustrating control of the smartphone 71. In FIG. 15, procedures similar to those in FIG. 9 are given same reference numerals, and description thereof will be omitted. Note that, in the present embodiment, an operation of the lens style camera 11 is similar to that in the second embodiment.

Now, it is assumed that a state of displaying a picked-up image from Camera 1, between Cameras 1 and 2, transitions to a state of displaying picked-up images of both of Cameras 1 and 2 as shown in FIGS. 7A and 7B. In this case, description will be made on an assumption that Camera 1 is the internal camera 81, and Camera 2 is the lens style camera 11 in the present embodiment.

The control section 75 of the smartphone 71 displays a picked-up image of the internal camera 81, which is Camera 1. In this case, the control section 75 has specified a photographing timing and the like to the internal camera 81, which is Camera 1, or has acquired photographing timing information directly from the internal camera 81, and the camera communication section 72 is not necessary for giving and receiving information to and from the internal camera 81. Therefore, the camera communication section 72 can be used exclusively for communication with the lens style camera 11. The control section 75 provides the photographing timing information and the like about the internal camera 81 to the lens style camera 11 via the camera communication section 72 (step S52). At step S4, the control section 75 requests a through image from the external lens style camera 11.

Next, the control section 75 performs judgment of a degree of similarity between the picked-up image from Camera 1 and the picked-up image from Camera 2 at step S53 and generates a warning according to the degree of similarity at step S54. By judging the degree of similarity, it is possible to judge whether or not an object is photographed by the two cameras in similar photographing states. If the degree of similarity is high, it can be judged that smooth switching from Camera 1 to Camera 2 is possible. On the contrary, if the degree of similarity is low, it can be judged that switching from Camera 1 to Camera 2 is not performed smoothly. Therefore, by generating a warning according to the degree of similarity, the control section 75 can perform operation support for smooth switching from the picked-up image of Camera 1 to the picked-up image of Camera 2 for the user. Note that, in the present embodiment also, methods similar to those of steps S6 and S7 of each embodiment described above may be used. Such image pickup section switching makes it possible to easily perform varied photographing and confirmation.

FIGS. 16A to 16C are timing charts for illustrating communication at a time of transition. FIG. 16A shows a period of communication with Camera 2 at the time of transition. FIG. 16B shows a timing of acquiring information from the internal camera 81. FIG. 16C shows information communication with the lens style camera 11.

As described above, in the present embodiment, the camera communication section 72 has to communicate only with the lens style camera 11, and the smartphone 71 and the lens style camera 11 can continuously communicate with each other.

As shown in FIGS. 16A and 16B, acquisition of information from the internal camera 81 is performed irrespective of a period of communication with the lens style camera 11. After a predetermined communication establishment processing period after start of communication with the lens style camera 11, information communication with the lens style camera 11 is performed.

In this case, the information about the photographing timing of the internal camera 81 and the like is provided to the lens style camera 11, and it is possible to acquire and display a picked-up image from the lens style camera 11 continuously after a picked-up image from the internal camera 81.

Other operations such as adjustment of timings of respective frames to be photographed to be same are similar to those of the second embodiment.

Further, though description has been made with a digital camera used as an apparatus for photographing in each of the embodiments of the present invention, a digital single-lens reflex camera, a compact digital camera or a camera for movie like a video camera and a movie camera is also possible as a camera. Further, an internal camera built into a portable information terminal (PDA: personal digital assistant), such as a mobile phone and a smartphone, is possible, of course. Industrial and medical optical apparatuses such as an endoscope and a microscope are also possible. A surveillance camera, an onboard camera, and a stationary type camera, for example, a camera attached to a television set or a personal computer are also possible.

The present invention is not limited to each of the above embodiments immediately, and the components can be modified and embodied within a range not departing from a spirit of the invention at a stage of practicing the invention. Further, various inventions can be formed by appropriately combining a plurality of components disclosed in each of the above embodiments. For example, some of all the components shown in the embodiments may be deleted. Further, components in different embodiments may be appropriately combined.

Note that, even if an operation flow in the claims, the specification and the drawings is described with “first”, “next” or the like for convenience, it does not mean that it is essential to perform the operation flow in that order. It goes without saying that, as for each of steps constituting the operation flow, such a part that does not influence essence of the invention can be omitted appropriately.

In the techniques described here, many of controls and functions described mainly with a flowchart can be set by a program, and the controls and functions described above can be realized by a computer reading and executing the program. A whole or a part of the program can be recorded or stored in a portable medium, for example, a nonvolatile memory such as a flexible disk and a CD-ROM, or a storage medium such as a hard disk and a volatile memory as a computer program product and can be distributed or provided at a time of shipment of the product or by a portable medium or through a communication line. A user can easily realize the display apparatus and display method of the present embodiments by downloading the program via a communication network and installing the program into a computer or by installing the program into the computer from a recording medium.

What is claimed is:

1. A display apparatus capable of switching and displaying, for a same object, a first picked-up image obtained by performing image pickup from a first point of view and a second picked-up image obtained by performing image pickup from a second point of view different from the first point of view, the display apparatus comprising:
a communication section performing signal transmission with each of a first image pickup section obtaining the first picked-up image and a second image pickup section performing image pickup from an angle different from an angle of an optical axis of the first image pickup section to obtain the second picked-up image;
an instruction inputting section inputting an instruction to select an image to be a display target between the first picked-up image obtained by the first image pickup section and the second picked-up image obtained by the second image pickup section; and
a display control section switching display of the first picked-up image and display of the second picked-up image, causing the display of the first picked-up image and the display of the second picked-up image to cooperate with each other.

2. The display apparatus according to claim 1, further comprising a control section instructing the first image pickup section or the second image pickup section to set an image-pickup angle of view and controlling at least one of photographing timings of the first and second image pickup sections before and after display switching between the first picked-up image and the second picked-up image, wherein
the control section acquires first information about image pickup of the first image pickup section from the first image pickup section or acquires second information about image pickup of the second image pickup section from the second image pickup section to control the photographing timing.

3. The display apparatus according to claim 1, further comprising a control section instructing the first image pickup section or the second image pickup section to set an image-pickup angle of view, wherein
the control section acquires first information about image pickup of the first image pickup section from the first image pickup section, acquires second information about image pickup of the second image pickup section from the second image pickup section, and judges whether or not both of the first and second image pickup sections are able to perform image pickup of the object, from the first information and the second information; and
the display control section performs display based on a result of the judgment by the control section.

4. The display apparatus according to claim 3, wherein
the first information is information about a distance to the object;
the second information is information about an angle of view; and
the control section judges an angle of view suitable for photographing from the distance information and the information about the angle of view and gives an instruction to change the angle of view to the judged angle of view.

5. The display apparatus according to claim 4, wherein
the control section sets an adjustment amount of an angle of view of the first or second image pickup section so that image pickup of the object is performed by the first and second image pickup sections simultaneously, based on a result of the judgment.

6. The display apparatus according to claim 1, wherein
the communication section performs time-division signal transmission with the first and second image pickup sections.

7. The display apparatus according to claim 1, wherein
one of the first and second image pickup sections is configured with an internal camera built into a portable terminal, and another is configured with a camera provided outside the portable terminal.

8. The display apparatus according to claim 1, further comprising a switching instruction inputting section inputting instruction for, when one image of the first and second picked-up images is displayed, selecting another image as a display target, wherein
if the instruction for selecting the other image as a display target is issued, the display control section displays only the other image after displaying the one image and the other image simultaneously.

9. The display apparatus according to claim 8, wherein
the control section sets angles of view of the first and second picked-up images to be substantially same during a period during which the one image and the other image are simultaneously displayed by the display control section.

10. The display apparatus according to claim 1, wherein
the control section sets image-pickup angles of view of the first and second image pickup sections to a maximum in an initial state.

11. A display method of switching and displaying, for a same object, a first picked-up image obtained by performing image pickup from a first point of view and a second picked-up image obtained by performing image pickup from a second point of view different from the first point of view, the method comprising:
performing signal transmission with each of a first image pickup section obtaining the first picked-up image and a second image pickup section performing image pickup from an angle different from an angle of an optical axis of the first image pickup section to obtain the second picked-up image;
in accordance with an instruction to select one image of the first and second picked-up images as an image to be a display target, receiving the first picked-up image from the first image pickup section and displaying the one image; and
in accordance with an instruction to select another image of the first and second picked-up images as an image to be a display target during the one image being displayed, receiving the second picked-up image from the second image pickup section and displaying the one image and the other image simultaneously, and, after that, displaying only the other image.

12. The display method according to claim 11, further comprising:
acquiring first information about image pickup of the first image pickup section from the first image pickup section, acquiring second information about image pickup of the second image pickup section from the second image pickup section, and judging whether or not image pickup of the object is performed simultaneously by the first and second image pickup sections; and
performing display based on a result of the judgment.
